(19) United States
(12) Patent Application Publication
(10) Pub. No.: US 2022/0351444 A1
(43) Pub. Date: Nov. 3, 2022

(54) ANIMATION PRODUCTION METHOD

(71) Applicants: XVI Inc., Chuo-ku (JP); Avex Technologies Inc., Minato-ku (JP)

(72) Inventors: Yoshihito KONDOH, Chuo-ku (JP); Masato MUROHASHI, Tokyo (JP)

(21) Appl. No.: 16/977,068

(22) PCT Filed: Sep. 24, 2019
(86) PCT No.: PCT/JP2019/037413

§ 371 Date: Aug. 31, 2020

(51) Int. Cl. G06T 13/40

(52) U.S. Cl. CPC G06T 13/40

(57) ABSTRACT

To enable to shoot animations in a virtual space, an animation production method, a computer executes a step of placing a virtual camera to shoot a character in a virtual space; and a step of placing in the virtual space a grid representing shooting range of the camera and a division line that divides the shooting.

### TECHNICAL FIELD

The present invention relates to an animation production method.

### BACKGROUND ART

Virtual cameras are arranged in a virtual space (see Patent Document 1).

### CITATION LIST

### Patent Literature

[PTL 1] Patent Application Publication No. 2017-146651

### SUMMARY OF INVENTION

### Technical Problem

No attempt was made to capture animations in the virtual space.

The present invention has been made in view of such a background, and is intended to provide a technology capable of capturing animations in a virtual space.

### Solution to Problem

The principal invention for solving the above-described problems is an animation production method wherein a computer executes a step of placing a virtual camera to shoot a character in a virtual space; and a step of placing in the virtual space a grid representing shooting range of the camera and a division line that divides the shooting.

The other problems disclosed in the present application and the method for solving them are clarified in the sections and drawings of the embodiments of the invention.

### Advantageous Effects of Invention

According to the present invention, animations can be captured in a virtual space.

### BRIEF DESCRIPTION OF DRAWINGS

FIG. 1 is a diagram illustrating an example of a virtual space displayed on a head mount display (HMD) mounted by a user in an animation production system 300 of the present embodiment.

FIG. 2 is a diagram illustrating an example of the overall configuration of an animation production system 300 according to an embodiment of the present invention.

FIG. 3 is a diagram schematically illustrating the appearance of the HMD 110 according to the present embodiment.

FIG. 4 is a diagram illustrating an example of a functional configuration of the HMD 110 according to the present embodiment;

FIG. 5 is a diagram schematically illustrating the appearance of the controller 210 according to the present embodiment.

FIG. 6 is a diagram illustrating an example of a functional configuration of a controller 210 according to the present embodiment;

FIG. 7 is a diagram illustrating a functional configuration of an image producing device 310 according to the present embodiment;

FIG. 8 is a diagram illustrating an operation of a camera 3 by a camera man 2 in an animation production system 300 according to the present embodiment;

FIG. 9 is a diagram illustrating an arrangement of a grid 31.

FIG. 10 is a view illustrating a state in which the camera 3 is taking a character 4 from the top.

FIG. 11 is a diagram illustrating adjustment of the position of the grid 31.

### DESCRIPTION OF EMBODIMENTS

The contents of embodiments of the present invention will be described with reference. The present invention includes, for example, the following configurations.

### Item 1

An animation production method wherein a computer executes:
a step of placing a virtual camera to shoot a character in a virtual space; and
a step of placing in the virtual space a grid representing shooting range of the camera and a division line that divides the shooting.

### Item 2

The animation production method according to claim 1, wherein
the computer further executes
a step of changing the position of the grid upon input from the user.

### Item 3

The animation production method according to claim 1 or 2, wherein
the computer further executes
a step of changing the size of the grid in response to a change in zoom of the camera.

A specific example of an animation production system 300 according to an embodiment of the present invention will be described below with reference to the drawings. It should be noted that the present invention is not limited to these examples, and is intended to include all modifications within the meaning and scope of equivalence with the appended claims, as indicated by the appended claims. In the following description, the same elements are denoted by the same reference numerals in the description of the drawings and overlapping descriptions are omitted.

### <Overview>

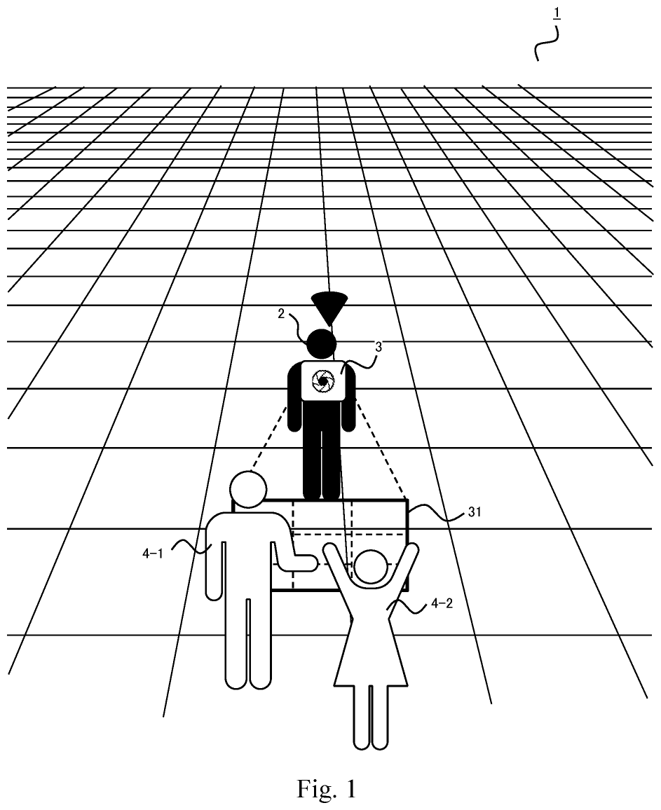

FIG. 1 is a diagram illustrating an example of a virtual space displayed on a head mount display (HMD) mounted by a user in an animation production system 300 according to the present embodiment. In the animation production system 300 of the present embodiment, a virtual character 4 and a virtual camera 3 are disposed in the virtual space 1, and a character 4 is shot using the camera 3. In the virtual space 1, a photographer 2 (a character of the photographer) is disposed, and the camera 3 is virtually operated by the photographer 2. In the animation production system 300 of this embodiment, as shown in FIG. 1, the user arranges the character 4 and the camera 3 while viewing the virtual space 1 in TPV (Third Person View) from the higher perspective, shoots the character 4 in the FPV (First Person View) as the photographer 2, and performs the performance of the character 4 in the FPV, while producing the animation. In the virtual space 1, a plurality of characters 4 (in the example of FIG. 1, characters 4-1 and 4-2) can be disposed, and the user can perform the performance while possessing a character 4. If more than one character 4 is disposed, the user may also switch the object possessed by each character 4 (e.g., characters 4-1 and 4-2). That is, in the animation production system 300 of the present embodiment, one can play a number of roles (roles). In addition, since the camera 2 can be virtually operated as the photographer 2, natural camera work can be realized and the representation of the movie to be shot can be enriched.

### <General Configuration>

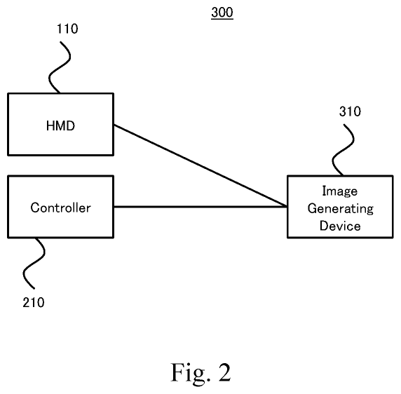

FIG. 2 is a diagram illustrating an example of the overall configuration of an animation production system 300 according to an embodiment of the present invention. The animation production system 300 may comprise, for example, an HMD 110, a controller 210, and an image generating device 310 that functions as a host computer. An infrared camera (not shown) or the like can also be added to the animation production system 300 for detecting the position, orientation and tilt of the HMD 110 or controller 210. These devices may be connected to each other by wired or wireless means. For example, each device may be equipped with a USB port to establish communication by cable connection, or communication may be established by wired or wireless, such as HDMI, wired LAN, infrared, Bluetooth™, WiFi™.The image generating device 310 may be a PC, a game machine, a portable communication terminal, or any other device having a calculation processing function.

### <HMD 110>

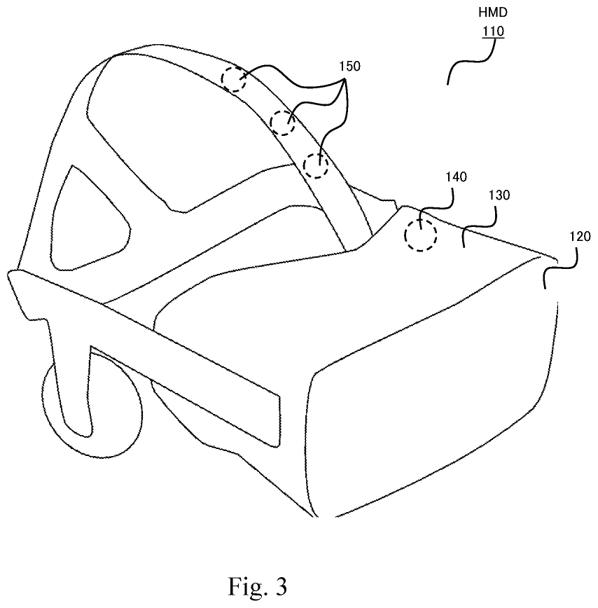

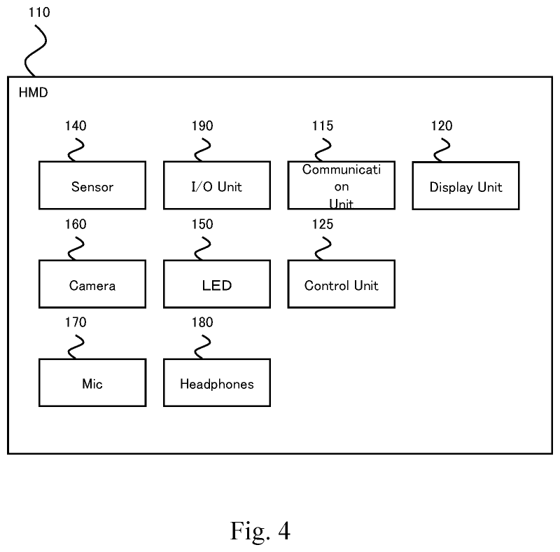

FIG. 3 is a diagram schematically illustrating the appearance of the HMD 110 according to the present embodiment. FIG. 4 is a diagram illustrating an example of a functional configuration of the HMD 110 according to the present embodiment.

The HMD 110 is mounted on the user's head and includes a display panel 120 for placement in front of the user's left and right eyes. Although the display panel 120 may be an optically transmissive or non-transmissive display, the present embodiment illustrates a non-transmissive display panel that can provide more immersion. The display panel 120 displays a left-eye image and a right-eye image, which can provide the user with a three-dimensional image by utilizing the parallax of both eyes. If left-eye and right-eye images can be displayed, a left-eye display and a right-eye display can be provided separately, and an integrated display for left-eye and right-eye can be provided.

The housing portion 130 of the HMD 110 includes a sensor 140. Sensor 140 may comprise, for example, a magnetic sensor, an acceleration sensor, or a gyro sensor, or a combination thereof, to detect movements such as the orientation or tilt of the user's head. When the vertical direction of the user's head is Y-axis, the axis corresponding to the user's anteroposterior direction is Z-axis, which connects the center of the display panel 120 with the user, and the axis corresponding to the user's left and right direction is X-axis, the sensor 140 can detect the rotation angle around the X-axis (so-called pitch angle), rotation angle around the Y-axis (so-called yaw angle), and rotation angle around the Z-axis (so-called roll angle).

In place of or in addition to the sensor 140, the housing portion 130 of the HMD 110 may also include a plurality of light sources 150 (e.g., infrared light LEDs, visible light LEDs). A camera (e.g., an infrared light camera, a visible light camera) installed outside the HMD 110 (e.g., indoor, etc.) can detect the position, orientation, and tilt of the HMD 110 in a particular space by detecting these light sources. Alternatively, for the same purpose, the HMD 110 may be provided with a camera for detecting a light source installed in the housing portion 130 of the HMD 110.

The housing portion 130 of the HMD 110 may also include an eye tracking sensor. The eye tracking sensor is used to detect the user's left and right eye gaze directions and gaze. There are various types of eye tracking sensors. For example, the position of reflected light on the cornea, which can be irradiated with infrared light that is weak in the left eye and right eye, is used as a reference point, the position of the pupil relative to the position of reflected light is used to detect the direction of the eye line, and the intersection point in the direction of the eye line in the left eye and right eye is used as a focus point.

### <Controller 210>

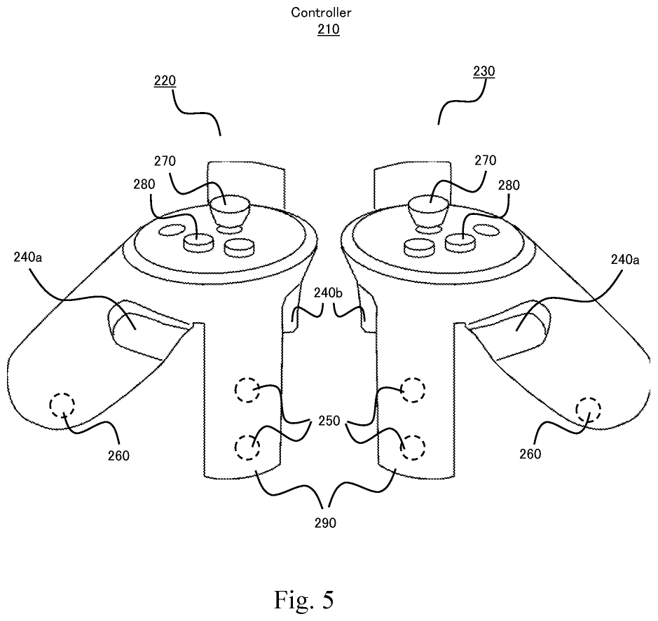

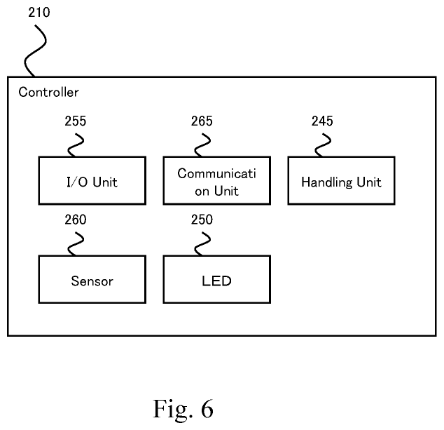

FIG. 5 is a diagram schematically illustrating the appearance of the controller 210 according to the present embodiment. FIG. 6 is a diagram illustrating an example of a functional configuration of a controller 210 according to this embodiment.

The controller 210 can support the user to make predetermined inputs in virtual space 1. The controller 210 may be configured as a set of left-hand 220 and right-hand 230 controllers. The left hand controller 220 and the right hand controller 230 may each have an operational trigger button 240, an infrared LED 250, a sensor 260, a joystick 270, and a menu button 280.

The operation trigger button 240 is positioned as 240a, 240b in a position that is intended to perform an operation to pull the trigger with the middle finger and index finger when gripping the grip 235 of the controller 210. The frame 245 formed in a ring-like fashion downward from both sides of the controller 210 is provided with a plurality of infrared LEDs 250, and a camera (not shown) provided outside the controller can detect the position, orientation and slope of the controller 210 in a particular space by detecting the position of these infrared LEDs.

The controller 210 may also incorporate a sensor 260 to detect movements such as the orientation and tilt of the controller 210. As sensor 260, it may comprise, for example, a magnetic sensor, an acceleration sensor, or a gyro sensor, or a combination thereof. Additionally, the top surface of the controller 210 may include a joystick 270 and a menu button 280. It is envisioned that the joystick 270 may be moved in a 360 degree direction centered on the reference point and operated with a thumb when gripping the grip 235 of the controller 210. Menu buttons 280 are also assumed to be operated with the thumb. In addition, the controller 210 may include a vibrator (not shown) for providing vibration to the hand of the user operating the controller 210. The controller 210 includes an input/output unit and a communication unit for outputting information such as the position, orientation, and slope of the controller 210 via a button or a joystick, and for receiving information from the host computer.

With or without the user grasping the controller 210 and manipulating the various buttons and joysticks, and with information detected by the infrared LEDs and sensors, the system can determine the movement and attitude of the user's hand, pseudo-displaying and operating the user's hand in the virtual space.

### <Image Generator 310>

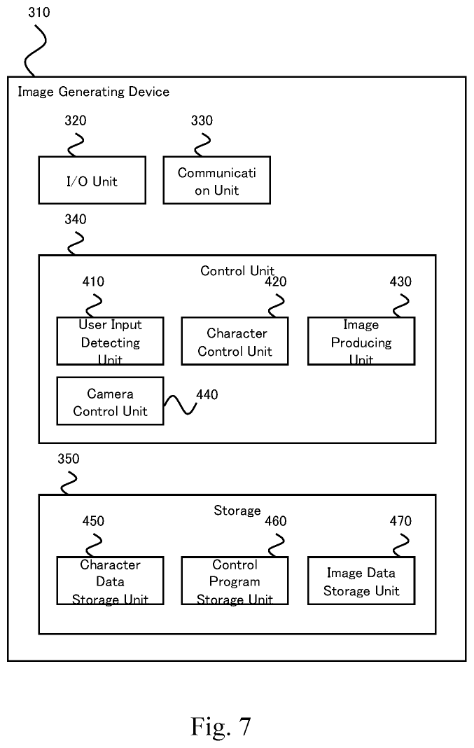

FIG. 7 is a diagram illustrating a functional configuration of an image producing device 310 according to the present embodiment. The image producing device 310 may use a device such as a PC, a game machine, a portable communication terminal, or the like, which has a function for storing information on the user's head movement or the movement or operation of the controller acquired by the user input information or the sensor, which is transmitted from the HMD 110 or the controller 210, performing a predetermined computational processing, and generating an image. The image producing device 310 may include an input/output unit 320 for establishing a wired connection with a peripheral device such as, for example, an HMD 110 or a controller 210, and a communication unit 330 for establishing a wireless connection such as infrared, Bluetooth, or WiFi (registered trademark). The information received from the HMD 110 and/or the controller 210 regarding the movement of the user's head or the movement or operation of the controller is detected in the control unit 340 as input content including the operation of the user's position, line of sight, attitude, speech, operation, etc. through the I/O unit 320 and/or the communication unit 330, and a control program stored in the storage unit 350 is executed in accordance with the user's input content to perform a process such as controlling the character 4 and generating an image. The control unit 340 may be composed of a CPU. However, by further providing a GPU specialized for image processing, information processing and image processing can be distributed and overall processing efficiency can be improved. The image generating device 310 may also communicate with other computing processing devices to allow other computing processing devices to share information processing and image processing.

The control unit 340 includes a user input detecting unit 410 that detects information received from the HMD 110 and/or the controller 210 regarding the movement of the user's head and the movement or operation of the controller, a character control unit 420 that executes a control program stored in the control program storage unit 460 for a character 4 stored in the character data storage unit 450 of the storage unit 350, a camera control unit 440 that controls the virtual camera 3 disposed in the virtual space 1 according to the character control, and an image producing unit 430 that generates an image in which the camera 3 captures the virtual space 1 based on the character control. Here, the movement of the character 4 is controlled by converting information such as the direction, inclination, and hand movement of the user head detected through the HMD 110 or the controller 210 into the movement of each part of the bone structure created in accordance with the movement or restriction of the joints of the human body, and applying the bone structure movement to the previously stored character data. The control of the camera 3 is performed, for example, by changing various settings (e.g., the position of the camera 3 within the virtual space 1, the shooting direction, the focus position, and the zoom of the camera 3) with respect to the camera 3 according to the movement of the hand of the character 4.

The storage unit 350 stores in the aforementioned character data storage unit 450 information related to the character 4, such as the attribute of the character 4, as well as the image data of the character 4. The control program storage unit 460 stores a program for controlling the operation and expression of the character 4 in the virtual space and controlling an object such as the camera 3. The image data storage unit 470 stores the image generated by the image producing unit 430.

### <Operation of Camera 3>

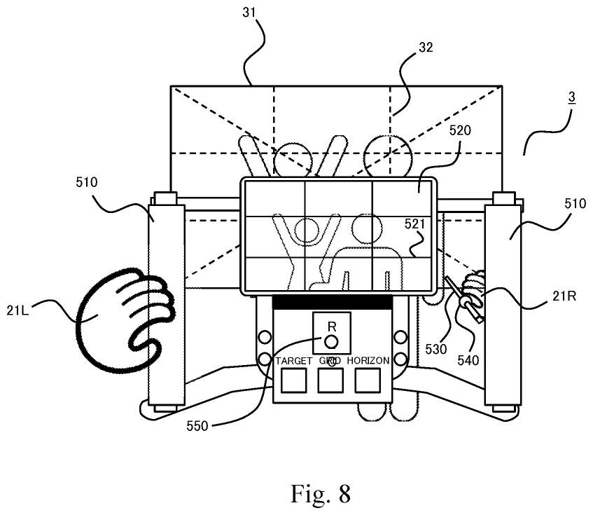

FIG. 8 is a diagram illustrating the operation of the camera 3 by the camera man 2 in the animation production system 300 according to the present embodiment. In FIG. 8, it is assumed that the user's possession target (to be operated) is set to Cameraman 2.

Each of the cameras 3 is provided with a handle 510 on both sides. The character control unit 420 (which may be the camera control unit 440; the same shall apply hereinafter) controls the movement of the camera man 2 by hand 21 in response to an input from the controller 210. For example, the position of the hand 21 is controlled in response to the position of the controller 210 and the grasping action of the hand 21 is controlled in response to the pushing of the trigger button 240. When the user's hand 21 grips the handle 510, the camera control unit 440 changes the position, posture (shooting direction), and focus position of the camera 3 according to the movement of the hand 21. The image displayed on the display unit 510 changes depending on the position, position, and focal position of the camera 3. That is, in the virtual space 1, the user can implement the camera work of the camera 3 by operating the controller 210.

A display unit 520 is provided in the camera 3. In the display unit 520, an image captured by the camera 3 in the virtual space 1 is displayed. In addition, the display unit 520 displays a split line 521 that is an auxiliary line for confirming the composition. In the example of FIG. 8, two vertical and horizontal split lines 521 are displayed which divide the screen into three sections. The user can operate the camera 3 while checking the image displayed on the display unit 520. That is, the photographer 2 can operate the camera 3 in the virtual space 1 without any actual camera work. In the vicinity of the display unit 520, a recording button 550 is disposed. When a recording button 550 is pressed, the image producing unit 430 records the image taken by the camera 3 as a moving image in the image data storage unit 470. When the recording button 550 is pressed again, the recording by the image producing unit 430 ends.

A slider 540 is also disposed on the camera 3. The user may move the hand 21 to grasp the slider 540 and move the slider 540 along the rail 530. In this embodiment, the race 530 is provided between the camera 3 and the subject to be shot (e.g., the character 4) and extends parallel to the anteroposterior direction (a direction parallel to the shooting direction of the camera 3 in which the shooting direction of the camera 3 is forward). The camera control unit 440 may adjust the zoom of the camera 3 in response to movement of the slider 540. For example, when the camera control unit 440 is moved so that the slider 540 is closer to the shooting object (in the shooting direction of the camera 3), the magnification ratio of the zoom of the camera 3 can be increased, and when the slider 540 is moved so that the slider 540 is closer to the camera 3 (in the direction opposite to the shooting direction of the camera 3), the magnification ratio of the zoom of the camera 3 can be reduced. The direction in which the slider 540 moves (the longitudinal direction of the rail 530) may not be parallel to the photographing direction of the camera, for example, the vertical direction or the left-right direction. The slider 540 may also be a rotational or spiral action instead of a linear operation.

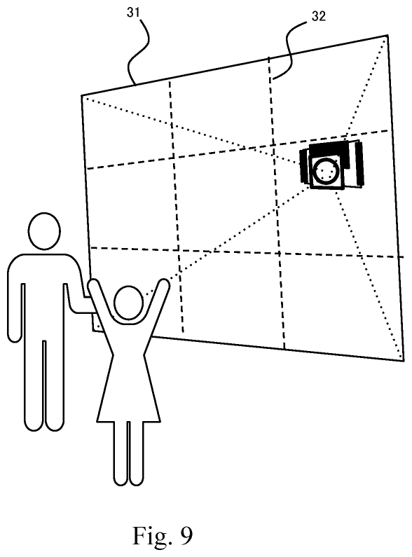

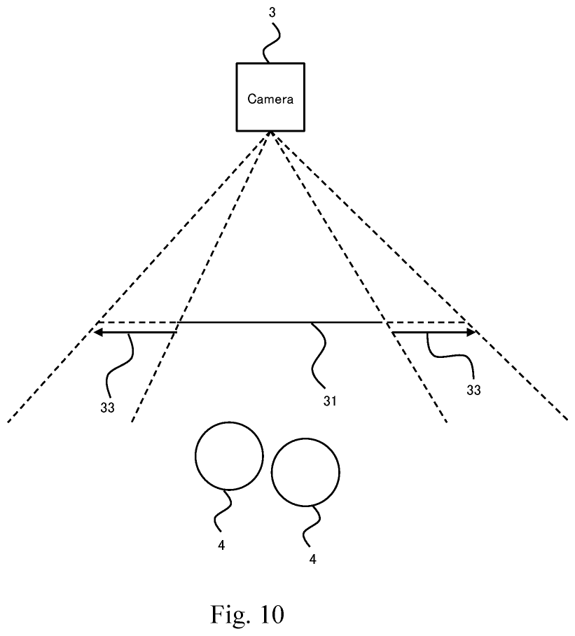

In virtual space 1, a grid 31 representing the shooting area of the camera 3 is disposed between the camera 3 and the character 4 (or some other object or virtual space 1 to be shot). FIG. 9 is a diagram illustrating an arrangement of a grid 31. The camera control unit 440 adjusts the size of the grid 31 according to the zoom of the camera 3. FIG. 10 is a diagram showing a state where the camera 3 is taking a character 4 from the top. The size of the grid 31 (length of height and width) is changed according to the zoom of the camera 3. For example, if the zoom magnification of the camera 3 decreases, the shooting area of the camera 3 expands and the size of the grid 31 increases. In FIG. 10, for example, if the zoom magnification of the camera 3 is reduced, the width of the grid 31 is increased as indicated by arrow 33.

The grid 31 is also provided with a split line 32. In this embodiment, four split lines 32 are provided to divide the rectangles of the grid 31 into three sections, one vertical and one horizontal. In addition to the three divisions, the dividing line 32 may be provided as a reference for the structure. For example, a split line 32 may be provided which divides the exposure range with a cross or gold ratio. From the viewpoint of the photographer 2, it is possible to confirm the structure with the dividing line 521 of the display unit 520, and the grid 31 is a guide mainly for the performer (the user who operates the character 4). That is, when the user operates the character 4 by possessing the character 4, the first person viewpoint of the character 4 can confirm where the camera 3 is shooting by using the grid 31. The parting line 32 also allows estimation of the configuration of the character 4. Accordingly, in the animation production system 300 of the present embodiment, the position of the grid 31 can be adjusted.

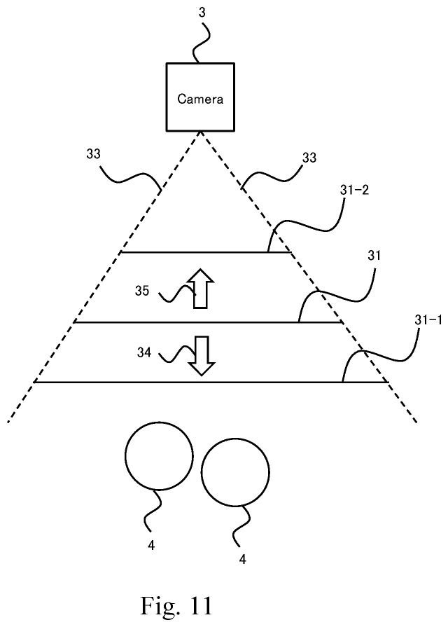

FIG. 11 is a diagram illustrating adjustment of the position of the grid 31. FIG. 11 is a top view of a situation where the camera 3 is shooting a character 4. The camera control unit 440 may, for example, move the position of the grid 31 between the camera 3 and the character 4 in parallel to the photographic direction of the camera in response to an indication from the controller 210 (for example, operation of the joystick 270). In this case, the camera control unit 440 automatically adjusts the size of the grid 31 in accordance with the shooting range (which is determined by the image angle of the camera 3, and is represented by the dotted line 33 in FIG. 11) which is determined according to the zoom of the camera 3. That is, in FIG. 11, the closer the grid 31 moves in the direction of the arrow 34 to the character 4, the larger the size of the grid 31 (31-1), and the smaller the size of the grid 31 moves in the direction of the arrow 35 away from the character 4 (31-2). The position designation between the camera 3 of the grid 31 and the character 4 can be made using the controller 210 when the user is operating the character 4. The designation of the position may be made when the camera man 2 is being operated. The camera control unit 440 automatically adjusts the size of the grid 31 according to the shooting range according to the specified position.

As described above, according to the animation production system 300 of the present exemplary embodiment, a user can operate the camera 3 as the camera man 2 in the virtual space 1 to take video images. Accordingly, since the camera 3 can be operated in the same way as in the real world to take photographs, it is possible to realize a natural camera work and to provide a richer representation of the animated video.

Further, according to the animation production system 300 of the present embodiment, the user can possess the character 4 and perform the performance of the character 4 using the controller 210 and the HMD 110. At this time, a grid 31 representing the shooting range of the camera 3 is displayed, and a split line 32 for grasping the structure is displayed on the grid 31. Accordingly, the performer of the character 4 can perform the performance while grasping the structure of the camera 3.

Although the present embodiment has been described above, the above-described embodiment is intended to facilitate the understanding of the present invention and is not intended to be a limiting interpretation of the present invention. The present invention may be modified and improved without departing from the spirit thereof, and the present invention also includes its equivalent.

For example, in the present embodiment, the image generating device 310 may be a single computer, but not limited to the HMD 110 or the controller 210 may be provided with all or some of the functions of the image generating device 310. It may also include a function of a portion of the image generating device 310 to other computers that are communicatively connected with the image generating device 310.

In the present exemplary embodiment, a virtual space based on the virtual reality (VR; Virtual Reality) was assumed. However, the animation production system 300 of the present exemplary embodiment is not limited to an extended reality (AR; Augmented Reality) space or a complex reality (MR; Mixed Reality) space, but the animation production system 300 of the present exemplary embodiment is still applicable.

In the present embodiment, the grid 31 is divided into three sections, vertically and horizontally, but a dividing line 32 that is divided in any number can be displayed.

In the present embodiment, the user possessed by the camera man 2 or the character 4 performs an operation to adjust the position of the grid 31. However, the position of the grid 31 may be adjusted in a state where the virtual space 1 is overviewed (the user is not possessed by the camera man 2 or the character 4). In this case, the user can grasp and move the grid 31.

In the present embodiment, the position of the grid 31 is specified by an operation such as the controller 210. However, the position of the grid 31 may not be limited thereto. For example, the grid 31 may be grasped and enlarged by the hand of the camera man 2, the hand of the character 4, or the hand of the user in the birds-eye mode. For example, the grid 31 can be enlarged or retracted by grasping, stretching, or retracting both sides of the grid 31, or both sides of the diagonal.

### EXPLANATION OF SYMBOLS

1 virtual space

2 cameraman

3 cameras

4 characters

31 Grid

32 split line

110 HMD

120 display panel

130 housing

140 sensor

150 light source

210 controller

220 left hand controller

230 right hand controller

235 grip

240 trigger button

250 Infrared LED

260 sensor

270 joystick

280 menu button

300 Animation Production System

310 Image Generator

320 I/O portion

330 communication section

340 controller

350 storage

410 User Input Detector

420 character control unit

430 Image Generator

440 Camera Control

450 character data storage section

460 Program Storage

470 Image Data Storage

510 handle

520 display

530 rail

540 slider

550 recording button

1. An animation production method wherein a computer executes:
a step of placing a virtual camera to shoot a character in a virtual space; and
a step of placing in the virtual space a grid representing shooting range of the camera and a division line that divides the shooting.

2. The animation production method according to claim 1, wherein
the computer further executes
a step of changing the position of the grid upon input from the user.

3. The animation production method according to claim 1, wherein
the computer further executes
a step of changing the size of the grid in response to a change in zoom of the camera.
